(19) United States
(12) Patent Application Publication
(10) Pub. No.: US 2005/0150604 A1
(43) Pub. Date: Jul. 14, 2005

(54) Apparatus for storing and dispensing a masking film

(75) Inventors: Frank Smits, Heesch (NL); Wouter Stinesen, Oosterhout (NL)

Correspondence Address: MCCORMICK, PAULDING & HUBER LLP, CITY PLACE II, 185 ASYLUM STREET, HARTFORD, CT, 06103, US

(73) Assignee: Ray Technology Group B.V., Drunen (NL)

(21) Appl. No.: 11/033,593

(22) Filed: Jan. 12, 2005

(30) Foreign Application Priority Data
Jan. 12, 2004 (EP) EP 04000429.3

(51) Int. Cl. B65D 83/00; B32B 31/00; B44C 7/00

(52) U.S. Cl. 156/510; 156/577

(57) ABSTRACT

A new apparatus is described for storing and dispensing a masking film, which apparatus comprises a housing body enclosing a roll compartment for receiving a roll of film, as well as a housing floor, a housing cover and a cutting apparatus. The housing body further comprises a dispensing slot for removing a masking film which is parallel to the roll axis and a cutting slot which is parallel thereto. A holder guide means is arranged in the housing cover, in which the cutting apparatus (4) with the blade held by the blade holder is movable along the cutting slot. A leaf spring provided on the blade holder holds the blade in the guide slot when the cutting apparatus is not used. When cutting is performed, the blade is pressed out of the guide slot into the cutting slot by pressing against the blade holder and the film is severed by simultaneous movement of the cutting apparatus along the cutting slot.

### PRIORITY CLAIM

Applicant hereby claims foreign priority under 35 U.S.C § 119 from European Application No. 04000429 filed 12 Jan. 2004, the disclosure of which is herein incorporated by reference.

### FIELD OF THE INVENTION

The invention relates to an apparatus for storing and dispensing a masking film rolled into a roll.

### BACKGROUND OF THE INVENTION

Such apparatuses are also known as film or masking film dispensers. They help attaching masking material present in the form of a roll to a surface and especially for attaching a masking material which is provided with an adhesive middle section at an edge on the longitudinal side or in the boundary region of the masking material on the longitudinal side.

In the case of painting or coating work it is frequently necessary that surfaces which are adjacent to or border the surfaces to be painted need to be covered. For this purpose it is possible to use a masking strip, e.g. a conventional adhesive tape with a limited adhesive effect which after the painting is removed again. Such conventional masking strips are usually sufficient for painting work with smaller brushes. Problems occur when the paint is sprayed, because the masking strip is usually not wide enough to cover adjacent surface parts and to protect them from inadvertent spraying. That is why masking or protective paper is often used in paint spraying, with a masking or adhesive strip being attached in a partly overlapping manner along an edge of the paper. The adhesive strip and the paper adhering to the same are then attached at the desirable location or surface by gluing. This procedure is cumbersome and time-consuming. Moreover, the paper sheet tends to pull the masking or adhesive tape in a downward direction, so that the same is torn from the bonded location, which is why the paper sheet frequently needs to be fixed additionally with pieces of adhesive tape.

Masking materials have already been proposed which substantially consist of a wide strip of paper or film and are provided on a longitudinal side with a self-adhesive adhesive agent. The film strip is present in the form of a supply roll. It is withdrawn from the roll and is fastened by means of the adhesive side along the edge region of the surface area to be masked.

The masking material is attached in such a way that one withdraws a suitable length from the supply roll, with the boundary part provided with the adhesive agent being fastened simultaneously in a suitable manner to the surface to be protected. Thereafter, the unrolled film section is cut off from the roll with scissors or a knife. In order to facilitate the application of the material, it has been proposed to house the supply roll in a drum or a box which is provided with a withdrawal opening and an adjacent severing or cutting strip, so that the masking material can be severed at a suitable length after the withdrawal. The cover material is pulled in sections from the drum or box, fastened with its edge provided with the adhesive agent to the surface that needs to be protected, thereafter a section is pulled from the drum again and processed, and so on until the desired surface section is masked. Thereafter the processed sheet is cut off along the cutting strip from the roll. The cutting means provided on the said apparatuses are usually sharp-edged and must therefore be handled with caution in order to prevent injuries.

### SUMMARY OF THE INVENTION

The invention is thus based on the object of providing an appliance or an apparatus which allows and achieves a simplified and improved application of masking material present in the form of a roll on the one hand and reduces to a minimum the likelihood of injury by the cutting apparatus of the appliance on the other hand.

This object is achieved by a masking film dispenser wherein a cover for the blade (15) is provided in the housing body and the cutting apparatus comprises means which holds the blade in a position covering the blade when the cutting apparatus is not in use and which allow sliding the blade transversally to the cutting direction from the cover to the cutting slot.

An advantageous embodiment of the masking film dispenser is explained in the description below by reference to the drawings and its function and handling is explained. The same reference numerals have been used in the figures for the same elements and first-time explanations relate to all figures, unless expressly mentioned otherwise.

### BRIEF DESCRIPTION OF THE DRAWING FIGURES

The accompanying drawings, which are incorporated into and constitute a part of this specification, illustrate one or more embodiments of the present invention and, together with the detailed description, serve to explain the principles and implementations of the invention. The figures are not to scale.

FIG. 1: shows a masking film dispenser in accordance with the invention with a cutting apparatus in a perspective view;

FIG. 2: shows a schematic representation of a partly cut-out view of a housing cover with the cutting apparatus;

FIG. 3: shows the housing floor of the masking film dispenser from the inside;

FIG. 4: shows the housing floor of the masking film dispenser from below;

FIG. 5: shows the blade holder with the handle and the inserted knife;

FIG. 6: shows a cross section through the masking film dispenser with the cutting apparatus.

### DETAILED DESCRIPTION OF THE PREFERRED EMBODIMENTS

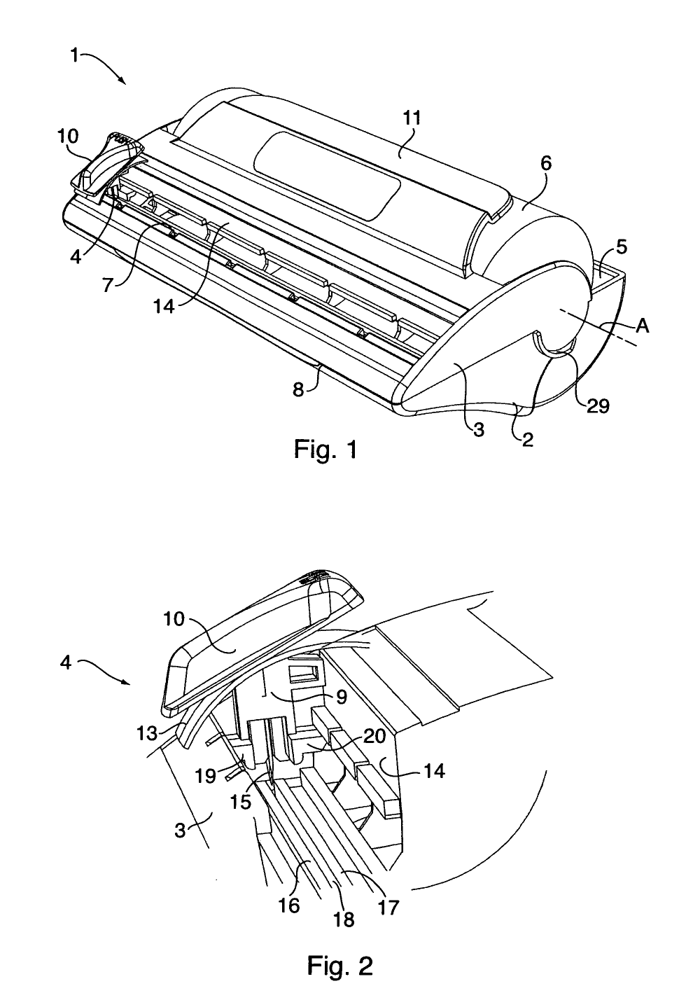

FIG. 1 shows an exemplary preferred embodiment of the masking film dispenser in accordance with the invention in a perspective representation. The masking film dispenser 1 substantially consists of a housing body which is composed of the housing floor 2 and a housing cover 3 as well as a cutting apparatus 4. The housing body 1 encloses the roller space 5 in which the masking film 6 having the shape of a roller is inserted. The cross section of the housing body 1 is shaped approximately like a drop or beak which is slightly circular at the back and tapers towards the front. The housing cover 3 is linked at its two lateral sides to the housing floor 2 and can be pivoted about the axis A which coincides with the axis of the film roll 6. When the cover 3 is closed, the front edges of the housing cover 3 and the housing floor 2 form the dispenser slot 8 through which the masking film 6 is pulled from the masking film dispenser. The cutting apparatus 4 consists of a blade holder guide means 7 which extends in the front region of the housing cover 3 over its entire width and of a blade holder 9 (cf. FIG. 2) with a blade which is arranged in a movable and spring-loaded manner in the blade holder guide means 7, and of guide elements in the interior of the housing body 1. The cutting apparatus 4 is arranged completely in the interior of the housing body 1, which means that the blade is moved in the interior of the housing during the cutting process and is completely covered by the housing body, which allows for safe working with the masking film dispenser.

FIG. 2 shows a schematic representation of a partly cut-out housing cover 3 with the cutting apparatus 4. The blade holder guide means is formed by a shaft 14 in the housing cover 3. Two U-shaped profiles 16, 17 are arranged parallel to the axis A in the floor of said shaft 14. The two profiles 16, 17 are guide elements of the blade holder 9. The two profiles 16, 17 are spaced from each other in such a way that they form in the floor of the shaft a downwardly open guide slot 18 for the blade 15 of the cutting apparatus 4. The cutting apparatus 4 thus comprises the blade holder 9 with the blade 15 clamped at the lower end. A leaf spring 13 is arranged at the upper end region of the blade holder 9, which spring engages at the end of shaft 14 into slots (not shown here) which extend parallel to the surface of the housing cover 3. The blade holder is spring-loaded in the vertical direction by said leaf spring 13 and is pressed upwardly in the direction towards the housing cover 3. The blade holder handle 10 forms the upper termination of the blade holder 9. The blade holder 9 can be moved along the shaft 14 or along the guide slot 18. The height of the blade holder 9 and the length of the blade 15 are configured in such a way that the blade 15 does not project from below out of the guide slot 18 when the blade holder 9 is not pressed. Only when the spring-loaded blade holder 9 is pressed downwardly in the direction towards the housing floor 2 during the cutting will the blade 15 project from the guide slot 18. This leads to the advantage that the blade 15 will only project from the guide slot 18 during the cutting process. The blade 15 is covered when the masking film dispenser is handled, i.e. when the film is processed or when the film roll is exchanged. This prevents any cutting injuries by the sharp blade. The blade holder 9 is provided at its lower end with runners 19, 20 which, when the blade holder 9 is pressed downwardly, engages in the U-shaped profile 16, 17 on the one hand and rest on the upper edges of the U-shaped profiles 16, 17 on the other hand. A precise guidance of the blade 15 along the cutting slot 23 is ensured by the engagement of the runners 19, 20 in the profiles 16,17.

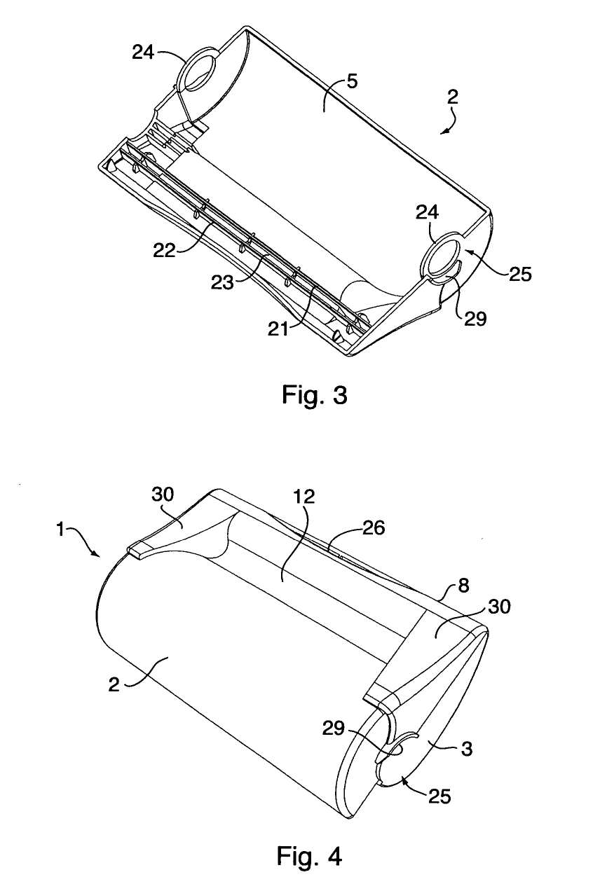

FIG. 3 shows an open housing floor 2. In the housing floor 2, two webs 21,22 are arranged in such a way that when the housing cover 3 is closed they each lie precisely below a U-shaped profile 16, 17 of the shaft 14. The intermediate space between the two webs 21,22 forms the cutting slot 23. The masking film 6 lies above the cutting slot 23 during the cutting process and is clamped between the webs 21,22 of the housing floor 2 and the lower edges of the U-shaped profiles 16, 17. By pressing the blade holder 9 in the direction towards the housing floor 2, the U-shaped profiles 16, 17 are pressed against the webs 21,22, as a result of which the masking film 6 is additionally tightly held (also see FIG. 6). The blade 15 pressed out of the guide slot 18 severs the masking film 6 when the blade holder 9 is pulled along the cutting slot 23. Once the blade holder 9 is released, the blade holder 9 with the blade 15 is lifted by the leaf spring 13 and the blade 15 is located in the guide slot 18 again.

Circular brackets 24 are attached to the two side walls of the housing floor 2, which brackets are used for receiving cylindrical formed parts on the side surfaces of the housing cover 3. These shaped parts extend in the direction of axis A and form with the brackets 24 the joints 25 for pivoting the housing cover 3 to the opened and closed position. At the same time, these cylindrical formed parts in the housing cover 3 are also used as the holding device for the masking film roll 6 in the roll compartment 5. The housing cover 3 is flipped upwardly by approximately 180° for exchanging the masking film roll. This is possible because the circular cross section of the housing cover 3 has a larger radius than that of the housing floor 2 in the region of the roll compartment 5. In the region of the joints 25, webs 29 are arranged on the side walls of the housing floor 2 along the outer circumference of the brackets 24. These webs 29 ensure that when the housing cover 3 is flipped upwardly its side walls are pressed apart in the region of the joints 25 in the direction of axis A. The roll holders are thus slightly pulled out of brackets 24 and the masking film roll can easily be removed from the roll holder and can be exchanged.

FIG. 4 shows the housing body of the masking film dispenser 1 from below. The handle trough 12 can be seen which is incorporated in the lower side of the housing floor 2 and which facilitates the holding of the masking film dispenser. The rectangular planar outer circumferential region 30 of the housing floor allows placing the masking film dispenser 1 on planar surfaces without the appliance rolling away. This also enables a further type of operation. The masking film dispenser can be positioned in the region of the surface to be covered and both hands are free for processing the masking film and for operating the device. Said circumferential region can additionally be provided with an anti-slip cover in order to place the masking film dispenser in a slip-free manner on the working surface. It can further be seen that the front edge of the housing floor comprises a slight depression 26 along the dispensing slot. Said depression 26 facilitates the grasping and opening of the housing cover 3 for withdrawing the masking film 6.

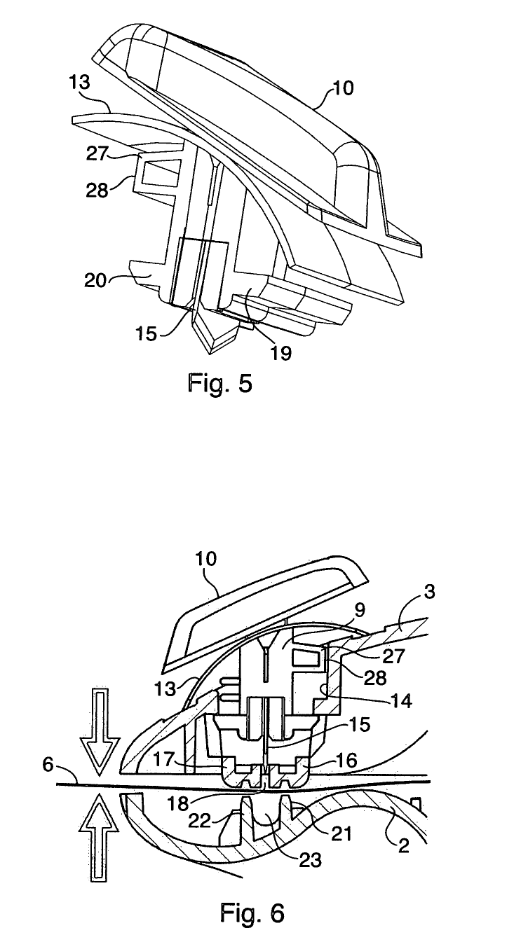

FIG. 5 shows the blade holder 9 in a perspective representation. A leaf spring 13 is arranged at the upper end region of the blade holder 9, which spring engages in slots extending parallel to the surface of the housing cover 3 and presses the blade holder 9 upwardly in the direction of the housing cover 3. As is shown in the preferred embodiment, said leaf spring 13 can be attached in an integral manner to the blade holder 9 and can consist of the same material as the blade holder 9. The upper termination of the blade holder 9 is formed by the blade holder handle 10. The blade 15 is inserted at the lower end of the blade holder 9. The blade 15 extends downwardly in an acute manner and comprises a cutting edge on both sides, so that the cutting apparatus works in both directions and can be used in both directions for cutting the masking film 6. In the lower end region, the blade holder 9 comprises runners 19, 20 which, when the blade holder 9 is pressed downwardly, engage in the U-shaped profiles 16, 17 on the one hand and rest on the upper edges of the U-shaped profiles 16, 17 on the other hand. The U-shaped profiles 16, 17 form a kind of rail for the blade holder 9, on which the blade holder 9 slides during the cutting. As a result of the engagement of the runners 19, 20 in the profiles 16, 17, a precise guidance of the blade 15 along the guide slot 18 and the cutting slot 23 is ensured. A shaped part which forms the sliding body 27 can be recognized in the upper region below the leaf spring 13. The sliding body 27 rests with its vertical side surface 28 on the side wall of shaft 14 and provides the blade holder 9 with additional stability during the cutting.

FIG. 6 now shows a partial cross section through the cutting apparatus 4, the housing floor 2 and the cover 3. It shows that the cover 3 is pressed against the housing floor 2 when the blade holder 9 is pressed downwardly (see arrows), and the film 6 is thus clamped between the U-shaped profiles 16, 17 and the webs 21, 22, so that a clean cutting edge can be achieved with the blade 15.

The size of the housing body 1 is chosen in such a way that the housing floor 2 and the housing cover 3 can be grasped easily with one hand. For this purpose, the two housing parts 2, 3 are provided in an ergonomic manner with the handle recess 12 in the housing floor 2 and the handle strip 11 on the housing cover 3. The housing body 1 is grasped with the right hand in such a way for example that the dispenser slot 8 faces to the front. The housing cover 3 is held with the thumb of the right hand and the other fingers of this hand grasp the housing floor 2. The cover is flipped upwardly at first with the thumb and the film end is grasped with the other hand and a short portion of film is retrieved from the roll. Thereafter the housing cover 3 is closed and the masking film required for masking is pulled through the dispenser slot 8 from the masking film dispenser 1. The cutting apparatus 4 is actuated with the other hand for cutting the film, such that the blade holder handle 10 is grasped, pressed in the direction towards the housing floor 3 and pulled towards the opposite end of the blade holder guide means 7. The work process is thus completed.

The masking film dispenser 1 in accordance with the invention allows a simple and smooth application of masking material present in the form of a roll. The likelihood of injury while working and using the appliance is reduced to a minimum because the blade 15 of the cutting apparatus is arranged within the interior of the appliance on the one hand and is thus covered by the appliance housing during the cutting process. On the other hand, the blade 15 is covered during the opening of the appliance by the guide slot 18 of the blade 15.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

1. An apparatus for storing and dispensing a masking film present in the form of a roll, comprising a housing body which encloses a roll compartment for receiving the roll to be inserted and is formed by a housing floor and a housing cover, and said housing body comprises a dispensing slot which is parallel to the longitudinal axis of the housing body and through which the unrolled end of the masking film can be guided, and a cutting slot which is parallel thereto and through which the end section of the unrolled masking film can be placed, and a holder guide means is arranged in the housing cover in which a blade holder of a cutting apparatus is movable along the cutting slot which blade holder comprises a blade held by the blade holder and acts on two sides in the direction of the cutting slot, wherein a cover for the blade is provided in the housing body and that the cutting apparatus comprises means which holds the blade in a position covering the blade when the cutting apparatus is not in use and which allow sliding the blade transversally to the cutting direction from the cover to the cutting slot

2. An apparatus according to claim 1, wherein the cover of the blade is formed by two U-shaped profiles which are arranged in the housing cover parallel to the longitudinal axis of the housing body in a shaft and are spaced from each other in such a way that they form in the shaft floor a downwardly open guide slot for the blade of the cutting apparatus, and that a leaf spring is provided in the upper end region of the blade holder which holds the blade in a position covering the blade when the cutting apparatus is not in use, which leaf spring engages at the upper end of the shaft in slots extending parallel to the surface of the housing cover and spring-loads the blade holder in the direction from the cutting slot to the housing cover and positions the blade in the guide slot when the blade holder is not loaded, and that by pressing against the blade holder in the direction towards the cutting slot the blade can be slid from the guide slot and into the cutting slot.

3. An apparatus according to claim 2, wherein the blade holder is provided at its lower end with runners which are designated, when the blade holder is pressed downwardly, to engage in the U-shaped profiles on the one hand and to thus ensure a precise guidance of the blade along the cutting slot during the cutting process, and to rest on the upper edges of the U-shaped profiles on the other hand and to thus press the same against the cutting slot.

4. An apparatus according to claim 1, wherein the housing cover is linked to the housing floor, such that the axis of the joint coincides with the roll of film placed in the roll compartment and the housing cover is held in a pivoting manner about said axis.

5. An apparatus according to claim 4, wherein webs are arranged in the region of the joints which ensure that when the housing cover is flipped open its side walls can be pressed apart in the region of the joints in the direction of the axis.

6. An apparatus according to claim 5, wherein the leaf springs are made of the same material as the blade holder and are integrally fixed to the same.

7. An apparatus according to claim 2, wherein the housing cover is linked to the housing floor, such that the axis of the joint coincides with the roll of film placed in the roll compartment and the housing cover is held in a pivoting manner about said axis.

8. An apparatus according to claim 7, wherein webs are arranged in the region of the joints which ensure that when the housing cover is flipped open its side walls can be pressed apart in the region of the joints in the direction of the axis.

9. An apparatus according to claim 8, wherein the leaf springs are made of the same material as the blade holder and are integrally fixed to the same.

10. An apparatus according to claim 3, wherein the housing cover is linked to the housing floor, such that the axis of the joint coincides with the roll of film placed in the roll compartment and the housing cover is held in a pivoting manner about said axis.

11. An apparatus according to claim 10, wherein webs are arranged in the region of the joints which ensure that when the housing cover is flipped open its side walls can be pressed apart in the region of the joints in the direction of the axis.

12. An apparatus according to claim 11, wherein the leaf springs are made of the same material as the blade holder and are integrally fixed to the same.

13. An apparatus according to claim 2, wherein the leaf springs are made of the same material as the blade holder and are integrally fixed to the same.

14. An apparatus according to claim 3, wherein the leaf springs are made of the same material as the blade holder and are integrally fixed to the same.
